(19) United States
(12) Patent Application Publication
(10) Pub. No.: US 2008/0040175 A1
(43) Pub. Date: Feb. 14, 2008

(54) SYSTEMS, METHODS AND APPARATUSES FOR ADVERTISEMENT EVOLUTION

(76) Inventor: Danielle F. Dellovo, North Andover, MA (US)

Correspondence Address: CHADBOURNE & PARKE LLP, 30 ROCKEFELER PLAZA, NEW YORK, NY, 10112, US

(21) Appl. No.: 11/748,456

(22) Filed: May 14, 2007

Related U.S. Application Data
(60) Provisional application No. 60/747,176, filed on May 12, 2006.
(60) Provisional application No. 60/747,405, filed on May 16, 2006.
(60) Provisional application No. 60/824,888, filed on Sep. 7, 2006.

(51) Int. Cl. G06Q 30/00; G06Q 10/00

(52) U.S. Cl. 705/7; 705/14

(57) ABSTRACT

The application discloses apparatuses, systems and methods for providing the generation, distribution, and tracking of advertisements and advertisement performance. Specifically, the disclosed system may be configured to generate a plurality of different advertisements based on the information contained in a single base data entry. The base data entry is processed in order to extract terms used to populate the advertisements, and the arrangements of base data entry terms and/or designs of the advertisements are directed by a plurality of advertisement generation routines. Distributed advertisements are tracked in order to assess the efficacy and/or performance success of various advertisement generation routines. The most successful and/or efficacious advertisement generation routines are preferentially utilized individually or in combination to generate subsequent generations of advertisements.

### PRIORITY CLAIMS AND RELATED APPLICATIONS

This disclosure claims priority to under 35 U.S.C. § 119 and incorporates by reference U.S. Provisional Patent Application Ser. No. 60/747,176, titled “Job Advertising Generation and Network for Distributing the Same,” filed May 12, 2006, Ser. No. 60/747,405, titled “Job Distribution Network,” filed May 16, 2006, and Ser. No. 60/824,888, titled “System and Method for Advertisement Generation, Selection and Distribution,” filed Sep. 7, 2006. The disclosure also incorporates pending, related non-provisional applications titled “Systems, Methods and Apparatuses for Advertisement Generation, Selection and Distribution System Registration,” filed May 14, 2007, as Ser. No. ______; “Systems, Methods, and Apparatuses for Advertisement Targeting/Distribution,” filed May 14, 2007 as Ser. No. ______; and “Systems, Methods and Apparatuses for Advertisement Generation,” filed May, 14, 2007, Ser. No. ______, which are all incorporated herein by reference.

### FIELD OF THE INVENTION

The present invention is generally directed to apparatuses, methods and systems for managing advertising. More specifically, the present invention is related to apparatuses, systems and methods for tracking advertising performance and generating advertising based on performance metrics.

### BACKGROUND OF THE INVENTION

Advertisements offering goods, services, or opportunities have varying degrees of performance success and/or effectiveness in achieving their goals. The effectiveness of an advertisement may depend, in part, on the way in which the advertisement is constructed, including the selection, design, and arrangement of advertisement features. In current advertising practices, advertisers, advertising directors, agencies, marketing consultants generally make subjective decisions of advertisement design that are based on personal preferences, career experience, or using focus groups as ‘test’ audiences.

### SUMMARY OF THE INVENTION

The present invention provides systems, methods and apparatuses for an Advertisement Evolution Engine (the “Engine”). More specifically, embodiments of the system are suited for quantifying advertisement performance in terms of a set of performance metrics and addressing issues that arise in generating advertisements that attract the attention of web users. The system may be configured to generate new advertisements that build on successful design aspects of previous generations of advertisements.

In accordance with one embodiment of the present invention, systems, methods and apparatus are disclosed for iteratively generating advertisements based on performance of distributed advertisements. One implementation of the process includes distributing a plurality of advertisements generated from the same base data entry (“BDE”) for evaluation. Performance rating parameters are received and processed to determine the relative efficacy of advertisement generation routines used to generate each of the plurality of advertisements. The most efficacious advertisement generation routines are preferentially ranked and implemented selected for generating subsequent distributed advertisements. In another implementation, aspects of the most efficacious advertisement generation routines may be preferentially combined into new advertisement generation routines to be used for generating new advertisements.

### BRIEF DESCRIPTION OF THE DRAWINGS

The accompanying appendices and/or drawings illustrate various non-limiting, representative, inventive aspects in accordance with the present disclosure:

FIG. 1 provides a conceptual illustration of Ad evolution within an embodiment of the present invention;

FIG. 2 provides an overview of various entities that may interact with the Engine at various points during system utilization;

FIG. 3 exhibits a high-level flow diagram illustrating aspects of the advertisement evolution process in one embodiment;

FIG. 4 illustrates Ad generation in according to a system embodiment;

FIG. 5 illustrates one embodiment of the incorporation of the same underlying BDE into different Ads using different Ad generation templates;

FIGS. 6a-d show embodiments of Ads administering passive and active performance metric registration;

FIGS. 7a-c show logic flow for system driven registration of passive performance metrics and web user drive registration of active performance metrics;

FIG. 8 provides an illustrative example of the logic flow in one embodiment of Ad evolution;

FIG. 9 exhibits a schematic illustration of a three generation evolution of Ad generation templates in one implementation of Ad duplication;

FIG. 10 provides an illustrative example of the logic flow in another embodiment of Ad evolution;

FIG. 11 shows an illustrative example of Ad recombination in one embodiment;

FIG. 12 provides a visualization of three successive Ad generation template generations in an Ad recombination embodiment;

FIG. 13 exhibits illustrates inventive aspects of the Engine controller;

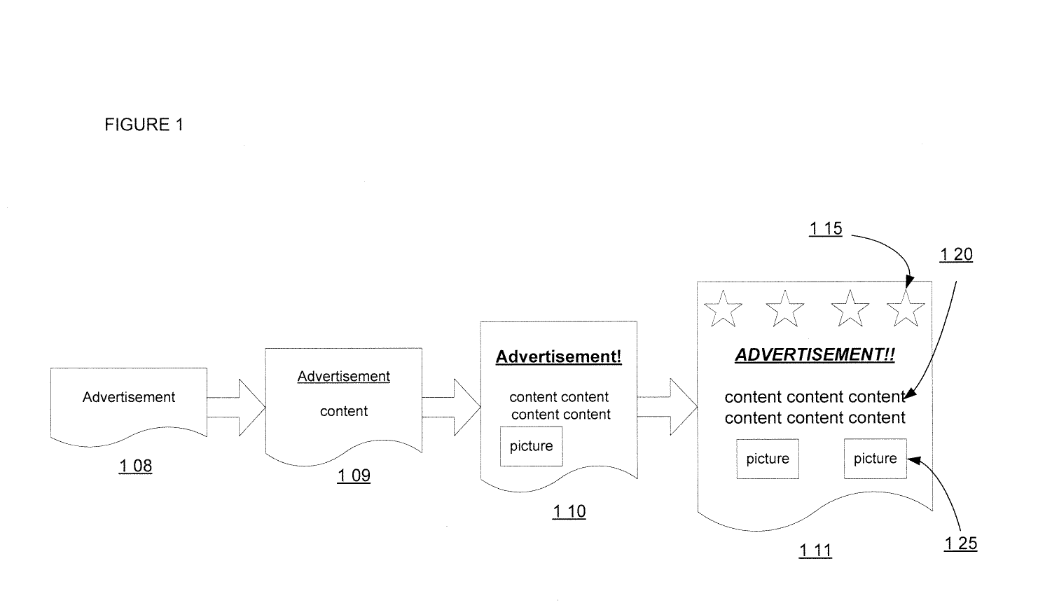

The leading number of each reference numeral indicates the first drawing in which that reference numeral is introduced. For example, content provider database (DB) 125 is first introduced in FIG. 1.

### DETAILED DESCRIPTION

The present disclosure includes a discussion of systems, methods, and apparatuses for an Advertisement Evolution Engine (hereafter “Engine”). The Engine may be configured to track advertisement performance and generate new advertisements based on performance metrics such as user responses to and/or interactions with existing advertisements. In one embodiment, the disclosed Engine is configured to interact with three entities: each of which is communicatively coupled to the Engine: (i) a content provider capable of transmitting and receiving data to a web user, for example media and advertisement content, (ii) a web user capable of receiving and interacting with displayed advertisements, as well as providing feedback and (iii) an underlying database entry host for generating and/or populating advertisements.

It is to be understood that, while the system may be described herein primarily in the context of web-printed advertisements (hereafter “Ads”), the system provides an administrator with significant flexibility and freedom to configure the system for any other number of information dissemination applications embodied in a wide array of media, including print, World Wide Web, television and radio, signs and billboards, product placement, postal and e-mail communications, and/or the like.

Furthermore, although the system may be described herein primarily in the context of evolving Ad generation templates, it is to be understood that, depending on the needs, parameters, specifications, etc. of a particular implementation, the system may be configured to evolve other advertising system functionality or processes. For example, a system administrator may configure iteratively optimized system modules including: Ad tracking routines, Ad targeting, Ad distribution routines, resume/job seeker profile generation routines, information dissemination/display routines, and/or the like.

Basic Overview

FIG. 1 provides a conceptual illustration of evolved advertisements according to an embodiment of the present invention. More specifically, the figure illustrates a representation of Ad evolution analogous to the archetypal illustration of organismic evolution. An Ad generation template lineage may begin at primitive and/or untested “ancestral stages” 108, and proceed through intermediate stages of adaptation (109, 110) to a “modern” stage (111). In the example shown in the figure, the Ad evolves from a simpler form (108) into one of greater complexity (111) by incorporating elements of the ‘successful’ advertisements as determined by the system. The characteristic features and/or elements of an evolving Ad (115, 120, 125) may be selected based on their capacity to make the Ad more effective.

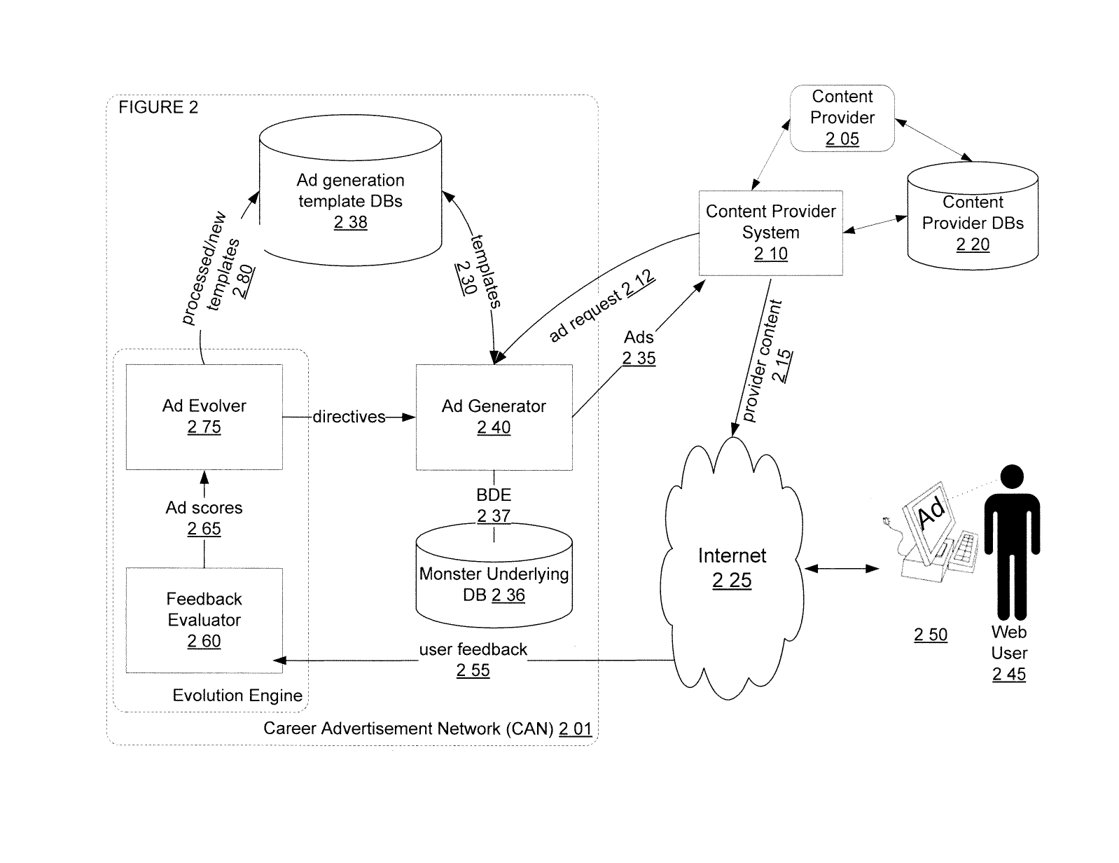

FIG. 2 provides an overview of various entities that may interact with the Engine at various points during system utilization. According to an embodiment of the invention, the Career Advancement Network (“CAN”) 201 includes the Engine and facilitates aspects of the functionality described herein. A content provider 205 connects with the CAN 201 via a Content Provider System 210 to request an Ad 212 from the CAN 201 for incorporation with provider content from Content Provider Databases 220. The combined provider content 215 and generated advertisement are displayed together to web user 245 on terminal 250.

Depending on the particular system specifications, the Content Provider System 210 may connect directly with the Engine as illustrated in FIG. 2. Alternately, the Content Provider System may connect with the Engine via an intermediary CAN 201 module. While in yet another implementation, the Content Provider System 210 connects with the Engine via an intermediary network such as the internet 225.

The CAN 201 retrieves Ad generation templates 230 from an Ad generation template database 238 based in part on provider content characteristics included as part of the ad request 212. The CAN system extracts and incorporates content from base data entries (BDEs) 237 which are stored on a BDE host entity's underlying data base 236 (e.g., a database with Monster job listings). The system processes extracted BDE content in accordance within an Ad Generator module 240 in accordance with a set of generation rules stored in the ad generation template DB 238. The generated ads 235 may be sent to the content provider system 210 for incorporation with the provider content 215 before final distribution across the internet 225 to web user 245.

For example, the content provider 205 may be configured as a sports news web site. The content provider 205 distributes various sports news content from the content provider's database 220. The CAN 201 may be configured to coordinate incorporating CAN generated advertisements 235 into the content 215 distributed by the content provider's system 210. The CAN 201 is configured to create the advertisement based on a variety of factors, some of which may include: a content provider's content 215, a content provider's advertisement system configuration, web user 245 characteristics, and/or any variety of other distribution metrics.

In one embodiment, the Ad generator selects an Ad generation template based in part on parameters generated in an Ad targeting/distribution process. Various implementations of the Ad targeting/distribution process are discussed in greater detail in co-pending related application, titled, “Systems, Methods and Apparatuses for Advertisement Targeting/Distribution” filed May, 14, 2007, Ser. No. ______, which is incorporated in its entirety herein by reference.

Web users 245 view distributed Ads on terminal computer systems 250 and provide passive/active feedback 255 to the CAN. In one embodiment, web users 245 register responses that are relayed to a feedback evaluator module 260 within the Engine. The feedback evaluator module 260 processes user responses 255 and generates a set of Ad scores 265 based on the responses. The scores may then be issued to an Ad evolver module 275, which uses the scores to process Ad generation templates and/or create new templates 280 for future use. These templates are managed by the Ad generation template databases 238.

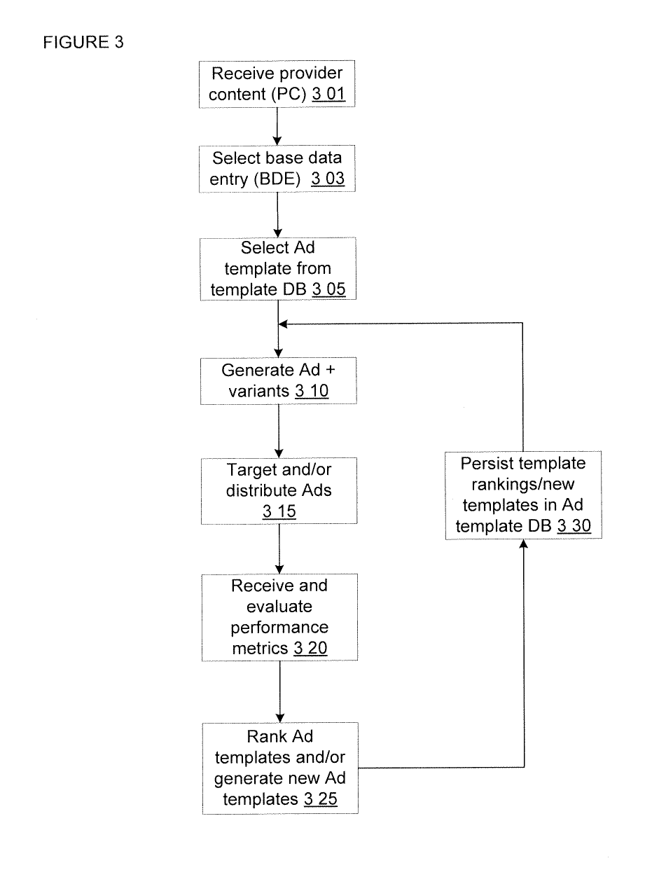

FIG. 3 is a high-level flow diagram illustrating aspects of the advertisement evolution process in one embodiment of the system. The system receives provider content from content provider/system affiliate 301, selects a BDE 303, and selects an Ad generation template from Ad generation template database (DB) 305. Extracted content from a BDE is organized into an Ad or Ads at 310 in accordance with instructions in the Ad generation template. The extracted content from a single BDE may be incorporated into a variety of different Ads based on BDE organizing instructions contained in various Ad generation templates.

Depending on the system implementation, Ads may be widely distributed and/or targeted to particular web users 315. After distributing the generated Ads 315, the system may receive web user feedback in the form of web user-Ad interaction and/or Ad evaluations 320. The system receives the feedback and derives a series of performance metrics by analyzing web user registered responses interacting with (passive feedback, e.g., click-throughs, mouse-overs, etc.) and/or reacting to (active feedback, e.g., ratings, etc.) the Ads. The system subsequently manages ranking Ad generation templates and/or generating new Ad generation templates 325 for populating the Ad generation template database 330 based on derived performance metrics 320. In managing the ad generation template database, the system is able to incorporate Ad features/elements from successful distributed Ads into future generations of distributed Ads that are expected to elicit particular user responses. The following discussion will discuss aspects of the FIG. 3 flow diagram in greater detail.

### DETAILED OVERVIEW

Ad Generation 310

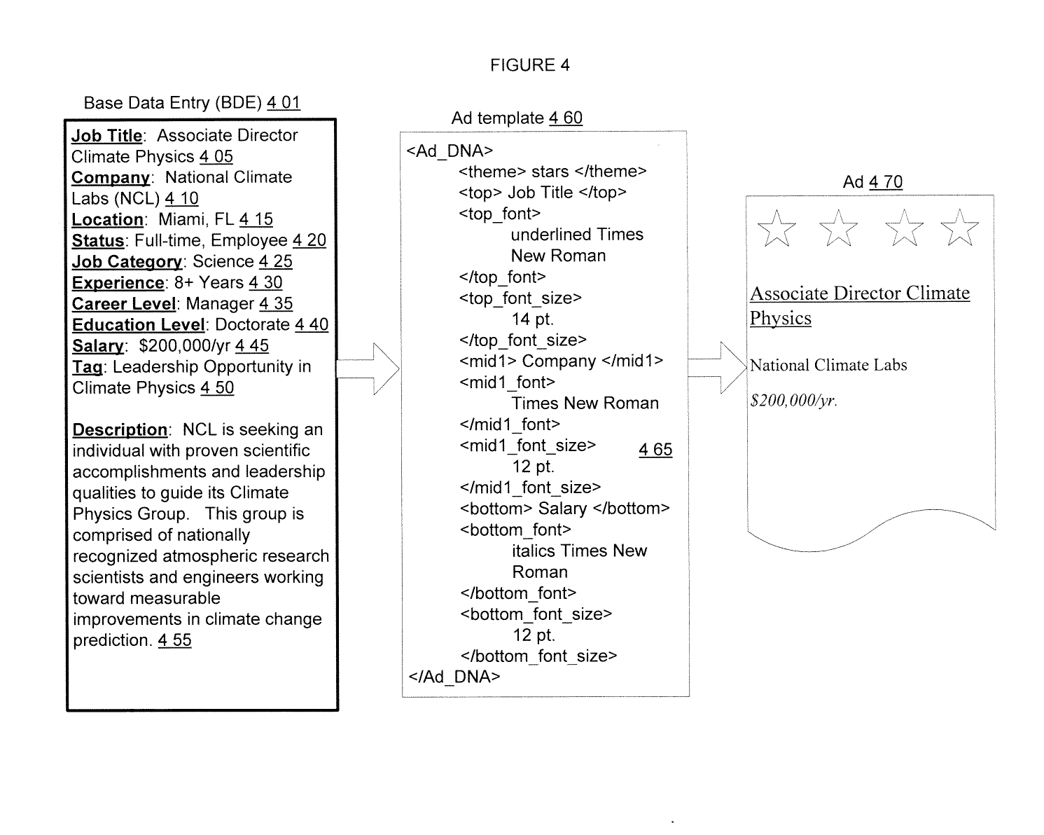

The advertisement generation process is discussed in greater detail in co-pending related application, titled, “System and Method for Advertisement Generation, Selection, and Distribution” Ser. No. ______, filed May 14, 2007, which is incorporated in its entirety herein by reference. Nevertheless, a brief discussion of particular embodiments of Ad generation is included here due to its immediate relevance. FIG. 4 illustrates Ad generation in one embodiment. A content provider requests an Ad from the CAN and may supply provider content characteristics that detail a content provider's content, a content provider's advertisement system configuration, web user 245 characteristics, and/or any variety of other distribution metrics.

This triggers the CAN to select a BDE 401 from an underlying Monster BDE database 238—in this case pertaining to a Monster.com job listing. The system then extracts BDE content such as the listing's job title 405, sponsor company 410, location 415, status 420, job category 425, required/desired experience 430, expected career level 435, required/desired education level 440, salary 445, job tag 450, and job description 455 as BDE elements.

In one embodiment, the BDE may be supplied in an XML format with a form such as:

<Job_Listing_BDE>

<ID> 012345 </ID>
<title> Associate Director Climate Physics </title>
<company> National Climate Labs (NCL) </company>
<location> Miami, FL </location>
<status> Full-time, Employee </status>
<category> Science </category>
<experience> 8+ years </experience>
<level> Manager </level>
<education> Doctorate </education>
<salary> $200,000/yr </salary>
<tag> Leadership Opportunity in Climate Physics

</tag>

<description>

NCL is seeking an individual with proven
scientific accomplishments and leadership
qualities to guide its Climate Physics Group.
This group is comprised of nationally
recognized atmospheric research scientists and
Engineers working toward measurable
improvements in climate change prediction.

</description>

</Job_Listing_BDE>

The incorporation of BDE content into an actual distributed Ad is instructed by an Ad generation template 460. Analogous to the way an organism's genetic sequence determines the expression of many of its traits, the Ad generation template 460 may determine Ad format, traits, characteristics, and/or elements of an advertisement. There exist a vast array of Ad characteristics that an Ad generation template may control or determine, including which BDE elements are incorporated into/omitted from an advertisements, as well as Advertisement format and characteristics such as layout, arrangement, and/or size of BDE elements and/or other Ad features, colors, fonts, multimedia content (e.g., images, animations, video, audio, etc.).

The generation template may also coordinate Ad themes, background designs, incorporation of and arrangement of interactive elements/widgets. Also, the generation template may be configured to define the Ad size, Ad type (e.g., in an internet-based Ad embodiment, the Ad type may specify pop-up, pop-under, banner, hover, interstitial web page, rich media banner, e-mail solicitation, redirect, and/or the like), Ad combinations, proximities of different Ads, and/or the like. In the embodiment shown in FIG. 4, the template instructing the expression of extracted BDE elements in a particular Ad is encoded in an XML format 465. The resulting Ad is displayed at 470.

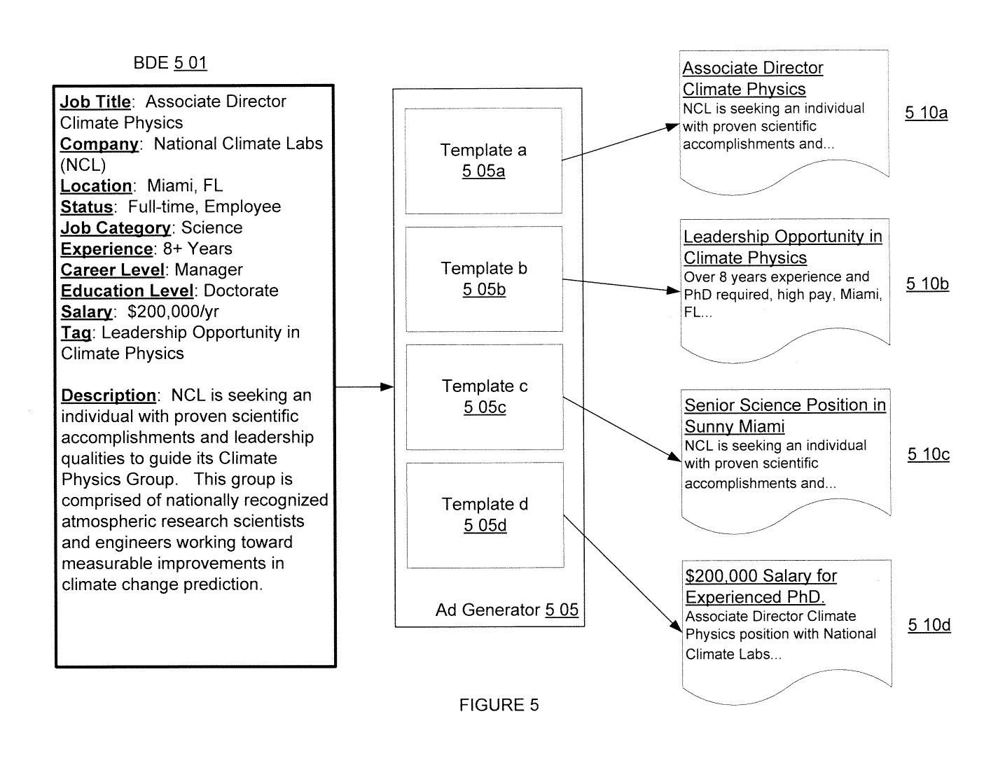

A single BDE may be incorporated into a diverse array of different Ads, yielding a sort of Ad biodiversity, via the employment of different Ad generation templates. FIG. 5 illustrates this principle in one embodiment, wherein a single BDE 501 (as in FIG. 4) is processed via the Ad generator 505 module through four generation templates (505a, 505b, 505c, 505d) to yield four different Ads with different styles and/or designs (510a, 510b, 510c, 510d). The Ads in this demonstrative embodiment, despite being built from the same BDE 501, each emphasize a different aspect of the job opportunity listing in the Ad heading (e.g., 510a emphasizes the job title, while 510d emphasizes salary and education level requirements). The different manner in which each Ad organizes and displays the BDE elements 501 may affect users differently and translate into different degrees of Ad performance success.

In one embodiment, two Ads generated from the same BDE using different Ad generation templates may be displayed simultaneously and/or in close proximity to each other. The simultaneous close proximity display facilitates a unique opportunity to obtain feedback for two distributed advertisements. More specifically, this implementation involves displaying the advertisements to a web user with the identical demographic information (because they are each displayed to the same web user). Accordingly, the system is able to obtain premium feedback regarding how distributed advertisements perform and more effectively gage which Ad (and, thus, which underlying Ad generation template) is more successful.

The Engine processes user feedback correlated to existing Ad generation templates to yield new Ad generation templates. In one implementation of the system, an initial pool of Ad generation templates may be set up at the outset of Engine operation, in order to supply a diverse set of Ad types for users to interact with and/or react to. The initial pool of Ad generation templates may reflect a variety of different compositions and be created by a variety of different means in various embodiments within the scope of the present invention. For example, in one embodiment, the initial pool of Ad generation templates may be manually created by a system administrator. In another embodiment, the Engine may analyze a collection of existing Ads to extract Ad generation templates. This may be accomplished, for example, by employing a variety of image, OCR, and/or text recognition and processing tools. In a further embodiment, a system user created generation template may be compared against system generation templates.

Web User Response Registration (255, 320)

Evolutionary success from a biological perspective essentially depends on an organism's (or, more fundamentally, a gene's) ability to successfully reproduce. Traits that are genetically determined (i.e., passed from one generation to the next) and promote reproductive success prevail in subsequent generations, while traits that inhibit reproductive success dwindle and die out as the organisms who carry them fall behind in sprouting offspring.

Similarly, an implementation of the system may employ various standards of performance success for evaluating Ad efficacy. The system may be configured to rank the Ads based on one or more performance characteristics. The ranking, in turn may be used to determine the propagation of particular Ad generation templates and/or Ad generation template elements in subsequent generations of Ads. Possible definitions of Ad success are widely varied and may differ depending on particular goals or requirements of different embodiments of the CAN. Some examples of Ad success may include Ad click-through numbers or rates (e.g., Ad click-throughs per impression, Ad click-throughs per day, etc.). Additional Ad performance characteristics may be based on Ad user ratings, Ad consummation numbers or rates (e.g., a purchase made based on an Ad click-through, a job interview/hire based on a job listing click-through, application submissions, new user registrations. Also, Ad performance characteristics may include any other type of post-click response that may be correlated with web user interactions with an Ad), mouse-overs (such as may be detected by an Ajax and/or JavaScript enabled software module), clicking on interactive Ad elements, mouse pointer tracking, head and/or eyeball movement tracking, time spent on an Ad, content provider requests for particular Ad generation templates, and/or the like.

In one implementation, only positive user responses are registered while in another implementation, both positive and negative user responses are registered, while in still another implementation, only negative user responses are registered. An example of a negative user response might be closing a window containing an Ad quicker than a specified minimum time period, a low and/or negative user rating, and/or the like. In one embodiment, only web user interactions with and/or responses to whole Ads are registered by the Engine, while in another embodiment, only web user interactions with and/or responses to elements within an Ad are registered by the Engine, while in yet another embodiment, web user interactions with and/or responses to both the entirety of Ads and to elements within Ads are registered by the Engine.

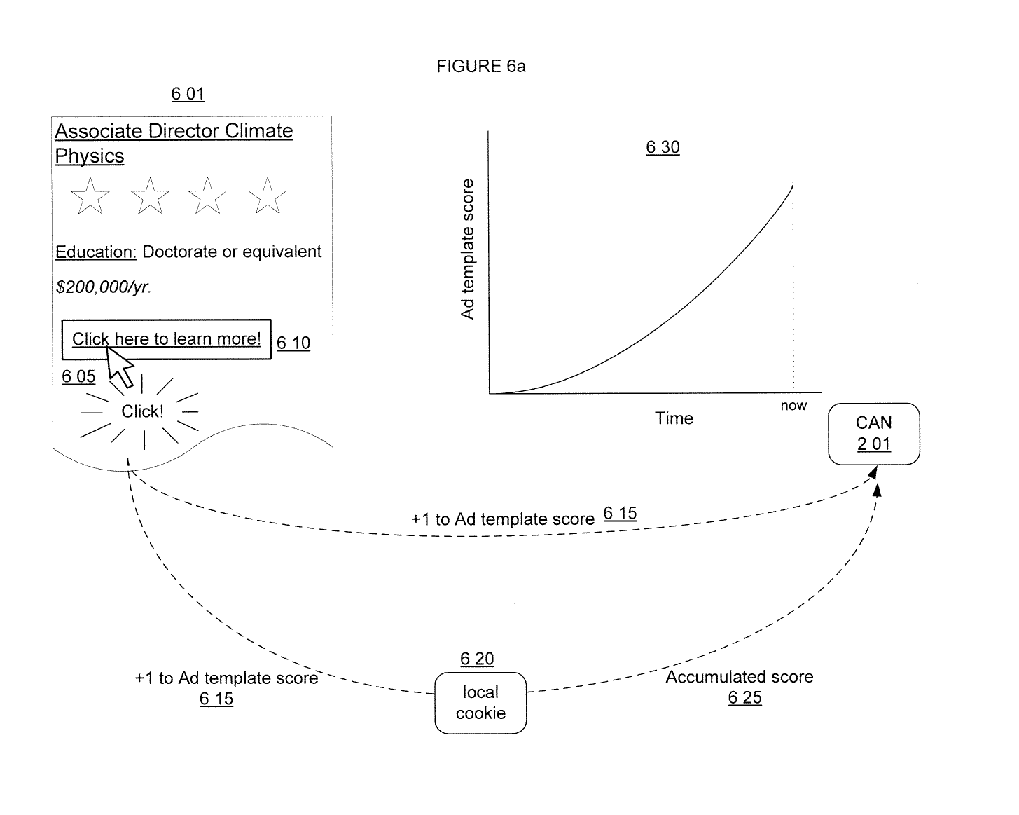

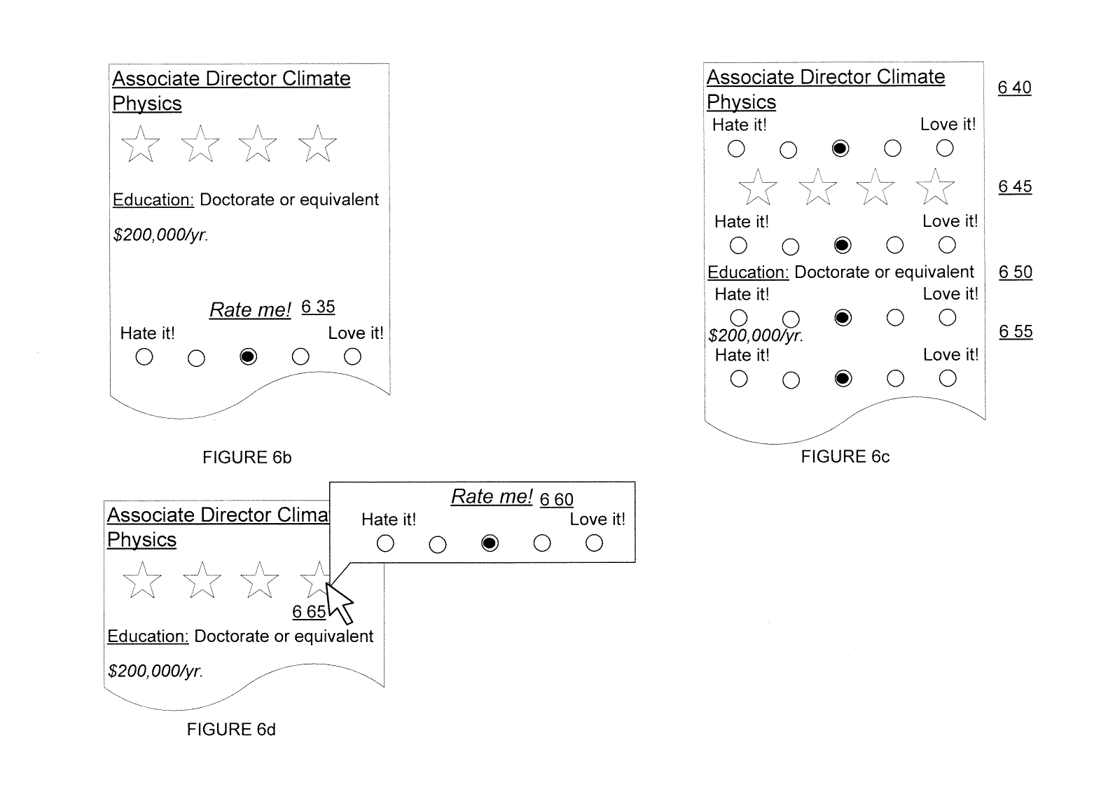

FIG. 6a shows an embodiment of an Ad receiving and processing passive performance metric registration based on web user click-throughs. A web user viewing an Ad 601 may decide to click 605 an interactive widget 610 in order to acquire more information. The system may include a feedback module as part of the landing page generation process. The feedback module creates a landing page providing the requested additional information and transmits a feedback indicator back to the system. As illustrated in FIG. 6a, the feedback indicator is configured as an increment 615 to the Ad generation template score 630 stored in the system. In one embodiment, the increment may initially occur to a record of the Ad generation template score in a cookie 620 stored locally on the web user's computer; the cookie may then upload an accumulated score 625 to the system at some later time.

FIGS. 6b-c show embodiments of Ads admitting active performance metric registration based on web user ratings of a whole Ad (FIG. 6b) or elements within Ads (FIGS. 6c and 6d). In FIG. 6b, a web user may rate their impression of the overall “quality” of the Ad using a radio button widget 635. A wide variety of other rating interfaces and mechanisms may be employed in different embodiments, including buttons, lists, scrollbars, sliders, text boxes, checkboxes, fields, menus, icons, and/or the like. In FIG. 6c, a radio button widget is provided after each Ad element (job title heading 640, clip art motif 645, education level requirement 650, and salary 655). Since the presence of rating widgets can, themselves, affect the appearance of an Ad, it may be desirable in some embodiments to hide the rating mechanism from immediate view. FIG. 6d shows an embodiment wherein the rating widget appears as a pop-up 660 only when the mouse pointer 665 is placed over an Ad element (in this case, the star motif).

Web user responses may also be registered for whole Ads or Ad elements within embodiments employing any other performance metrics. Ad element ratings may be considered during creation of new Ad generation templates, whereby collections of highly rated Ad generation template elements are compiled to create new Ad generation templates. Details surrounding creation of new Ad generation templates, including based on compilations of highly rated Ad generation template elements, are discussed below.

In some system implementations, the pop-up rating widget 660 may be activated on a volunteer's local terminal. The volunteer may be a web user who has agreed to provide feedback to distributed advertisements and identified as a volunteer by processing cookie information stored on their local system. In one embodiment, the Engine may be configured to restrict registration of web user responses and/or interactions for a given, unique web user (e.g., such as may be designated by a unique IP address). For example, the Engine may elect to accept a limited number of web user responses from a particular web user, for a particular Ad, within a particular interval of time, and/or the like.

Feedback Evaluation (260, 320)

In one embodiment, web user responses and/or interactions registered by the Engine are directed to the Feedback Evaluator module 260 for subsequent processing. The Feedback Evaluator module may track web user responses/interactions and, in turn, convert them into scores or rankings for Ads and/or Ad elements.

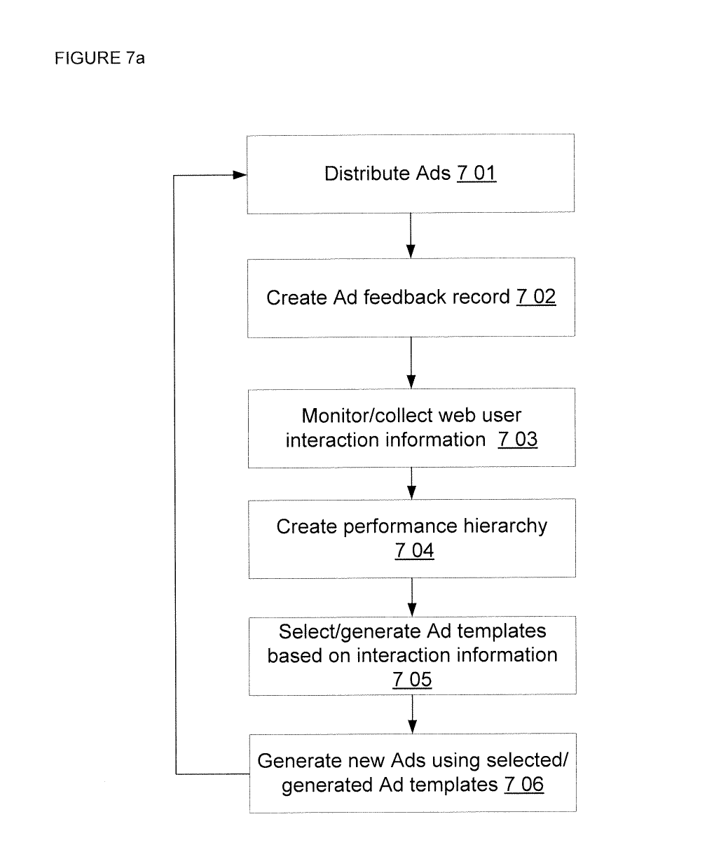

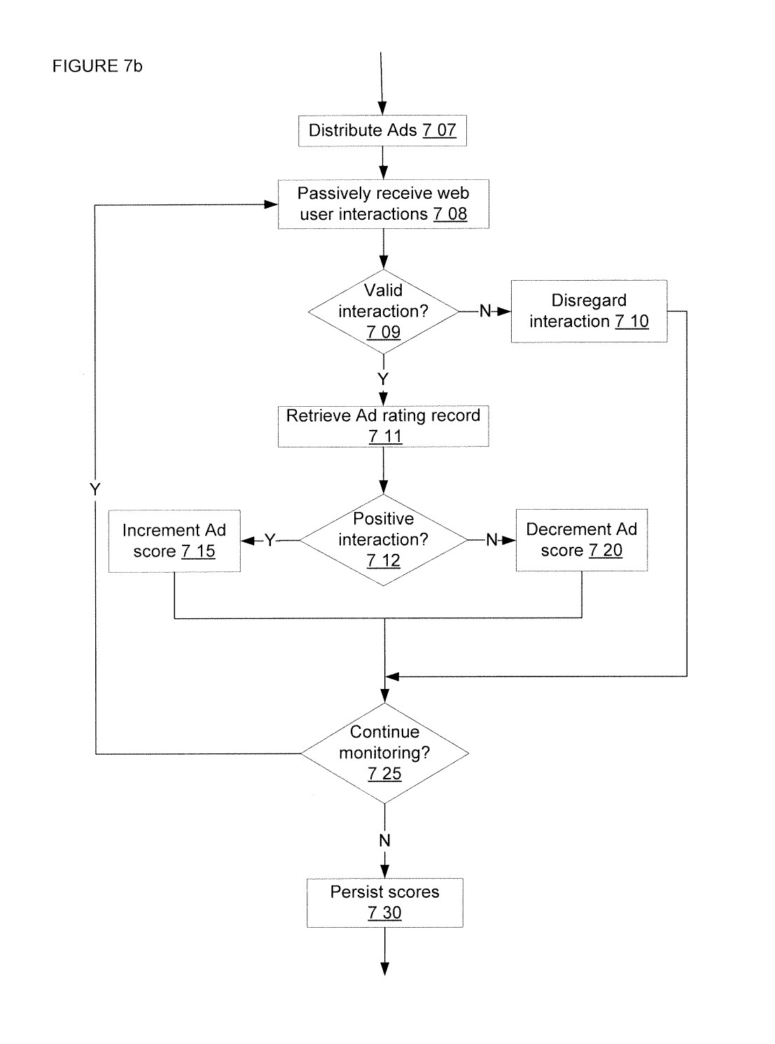

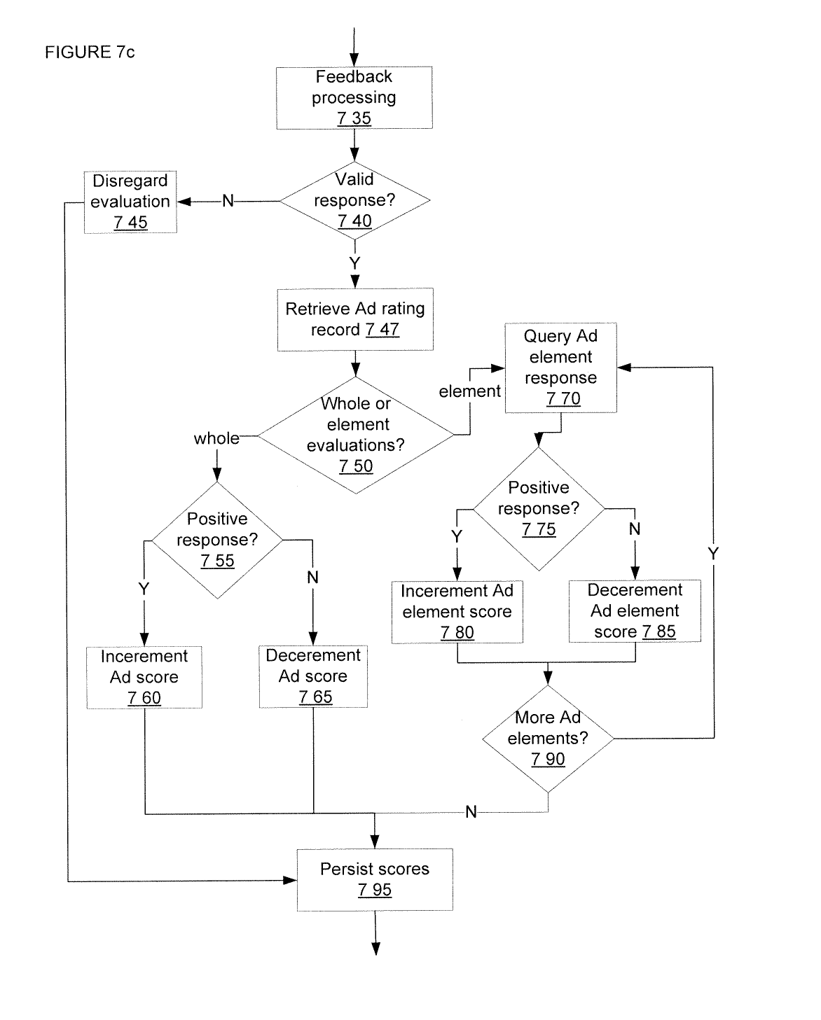

FIG. 7a shows high-level logic flow for system driven analysis of passive performance metrics. At 701, Ads are widely distributed and/or targeted to particular web users. At 702, the system creates Ad feedback records corresponding to the distributed Ads that may be configured to track Ad performance metrics. At 703, the system monitors web user interactions with Ads and/or collects information regarding web user interactions with Ads that may be stored in corresponding Ad feedback records. In one implementation, the system may install cookies on web user computers that are capable of tracking and/or monitoring web user interactions with Ads and relaying interaction information back to the system. At 704, the system may create a performance hierarchy of distributed Ads based on performance metrics collected in Ad feedback records. At 705, the system preferentially selects Ad generation templates and/or generates new Ad generation templates based on collected web user interaction information and/or the performance hierarchy created at 704. The Ad generation templates selected and/or generated at 705 are employed at 706 to create new Ads that are then re-distributed to web users.

FIG. 7b shows detailed logic flow for system driven registration of passive performance metrics in according to an embodiment of the system. Ads are distributed to web users at 707 and the system passively monitors web user interactions with the Ads 708. Thereafter, the system may receive a notice of a web user interaction whenever such an interaction occurs or at regular intervals. For example, the system may install a cookie on the web user's computer that collects web user-ad interaction information and periodically uploads the information to the system.

Received interactions are evaluated to determine whether they are valid at 709. An example of an invalid interaction may be a second click-through indication associated with an Ad for which the same web user has registered a previous click-through within a predetermined duration of time (e.g., the last 10 minutes). Invalid interactions are disregarded at 710, while Ad rating records are retrieved for valid interactions at 711. The valid interactions are evaluated to determine whether they are positive or negative 712 and the corresponding Ad generation template score is incremented 715 or decremented 720.

In another embodiment, the received interactions may pertain to elements of the Ad generation template rather than the Ad generation template as a whole. Consequently, Ad generation template elements may be scored separately. The system determines at 725 if the present round of persistent monitoring should continue. If the system determines the round is complete, the Ad generation template scores are persisted 730. For example, the system may update and save the performance data associated with the Ad generation template in the Ad generation template database.

FIG. 7c shows detailed logic flow for web user driven registration of active performance metrics in one embodiment that admits evaluation of both whole Ads and Ad elements. Initial processing of web user feedback is performed at 735, and a determination is made as to whether the response is valid at 740. An example of an invalid web user response may be the entry of unacceptable characters in a text-box based web user rating interface. Another example of an invalid web user response may be a response from the same web user for the same Ad within a predetermined duration of time.

Invalid web user responses are disregarded 745, while Ad rating records are retrieved for valid web user responses at 747. Valid responses are evaluated at 750 to determine whether they are responses to a whole Ad or to Ad parts/elements. In another embodiment, only whole Ad responses are allowed, while in another embodiment, only Ad element responses are allowed. For a whole Ad response, a determination is made as to whether a positive or negative response has been registered 755, and the score for the corresponding Ad generation template is incremented 760 or decremented 765 depending on whether the response is positive or negative respectively. In another embodiment, only positive Ad responses are registered while, in yet another embodiment, only negative Ad responses are registered. At 795, the Ad generation template scores are persisted.

In an implementation of the system, the Engine is configured with an Ad scoring management module. The scoring module manages rankings of various generation templates and/or template elements, depending on the implementation. If the Engine determines at 750 that Ad elements have been evaluated, then the response for a given Ad element is queried at 770. Depending on whether the score is positive or negative 775, the score corresponding to the Ad element in question is incremented 780 or decremented 785. If there are more Ad element responses, the Engine returns to 770. If not, then the Ad element scores are persisted at 795. In one embodiment, new Ad generation template and/or Ad generation template element scores replace older Ad generation template and/or Ad generation template element scores, while in another embodiment, new Ad generation template and/or Ad generation template element scores are appended to a historical record of Ad generation template and/or Ad generation template element scores. It is to be understood that the Ad scoring management module may simply update Ad scores or maintain historical scoring records for whole Ad generation templates as well.

Maintaining historical records of Ad scores enables the Engine to track Ad success over successive Ad generations and through various adjustments and/or variations in Ad style and/or design. Furthermore, Ad success may be resolved over a variety of independent variables, including time, location, Ad style and/or design, Ad characteristic(s) and/or element(s), and/or the like. Success records may be evaluated by Engine administrators, content providers, and/or BDE providers to determine trends and/or factors affecting the success of Ads and Ad generation templates.

There are a wide variety of possible scoring system implementations for Ad generation templates and/or Ad generation template elements that may be applied within various embodiments of the present invention, depending on specific goals and/or requirements of a specific implementation. In one embodiment, a numerical value associated with particular types of web user responses may be added to or subtracted from the Ad generation template and/or Ad generation template element score. For example, each click-through for a given Ad may increment the corresponding Ad generation template score by +1 (see, e.g., FIG. 6a). For another example, values of −2, −1, 0, +1, and +2 may be associated with each of the options between “Hate it!” and “Love it” in the radio button embodiment shown at 635 in FIG. 6b. In another embodiment, a minimum number of responses of a particular type must be registered before an Ad generation template score is adjusted (e.g. each time an Ad click-through is registered).

In another embodiment of Ad generation template and/or template element scoring, a score reflecting a probability (i.e., between 0 and 1) may be assigned to each Ad generation template and/or Ad generation template element and increased or decreased based on web user responses and/or interactions. For example, an initial score of S=0.5 may be assigned to a new Ad generation template. A negative web user response, then, may change the Ad generation template score to SAN, where N is some positive real number greater than 1.

For example, for N=1.1, a single negative web user response would change the Ad generation template score from S=0.5 to S=0.467. A positive web user response, then, may change the Ad generation template score to the N-th root of S [or, equivalently, Sˆ(1/N)]. Thus, for N=1.1, a single positive web user response would change the Ad generation template score from S=0.5 to S=0.533. In the limit of a large number of negative responses, the score will approach 0 while, in the limit of a large number of positive responses, the score will approach 1. The rate at which these limits are approached and that template scores will vary with each response in this embodiment is determined by the exponent N. A particular use for an embodiment with scores reflecting probabilities will be made apparent within embodiments of Ad evolution discussed in the next section.

In one embodiment, a total Ad generation template score may be derived from the scores for the Ad generation template elements of which the Ad generation template is composed, such as by adding up all of the composite Ad generation template element scores. In another embodiment, Ad generation template element scores may be assigned based on the score of the overall Ad generation template of which they are a part. For example, all of the elements of a particular Ad generation template may be assigned the same score as the Ad generation template itself.

Ad Evolution (275, 325)

In one embodiment, scores assigned to Ad generation templates and/or Ad generation template elements may be directed to the Ad Evolver module 275. The Ad Evolver module may be configured to process the scores in order to rank existing Ad generation templates and/or to generate new Ad generation templates. Ad generation templates and/or Ad generation template elements having higher scores may be directed by the Ad Evolver module to be more prevalent in subsequent Ad distribution than those having lower scores. This may be accomplished in a number of different ways within various embodiments of the present invention.

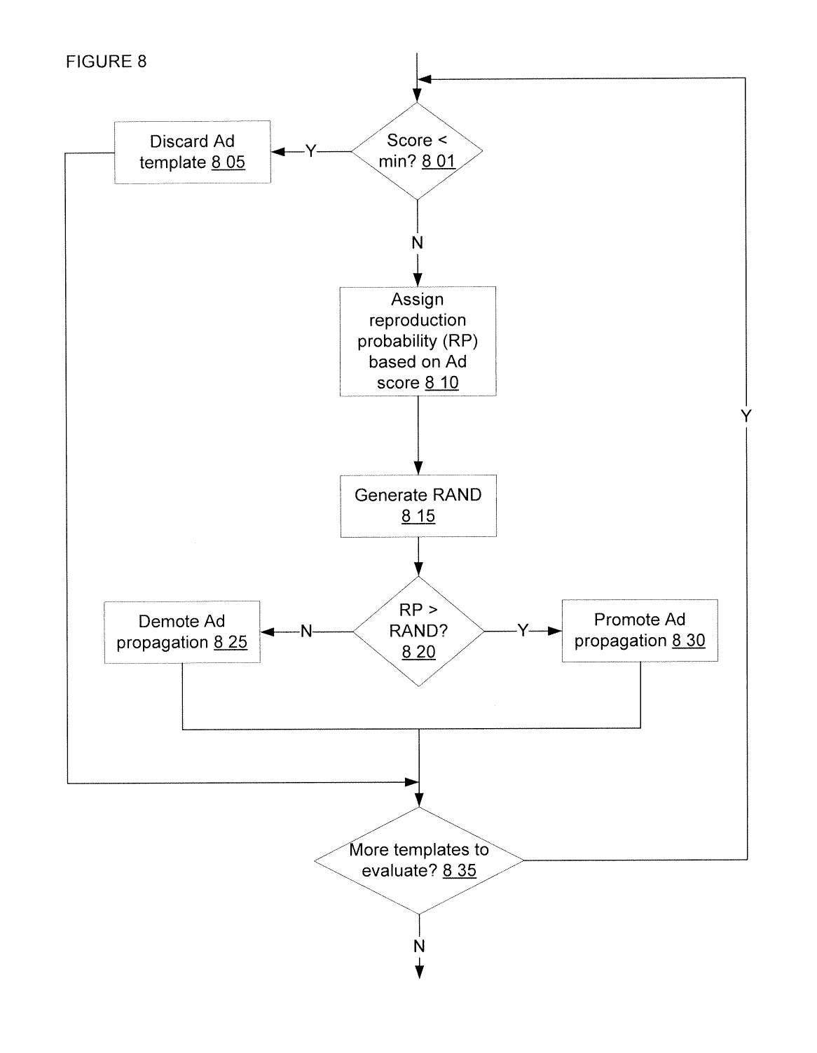

FIG. 8 provides an illustrative example of a logic flow in one embodiment of Ad evolution. In this embodiment, referred to as “Ad duplication”, web user responses to whole Ads are registered and processed by the Feedback Evaluator module 260 and passed to the Ad Evolver module 275. At 801, the Ad Evolver checks if the Ad generation template score is less than some minimum value. If so, the particular Ad generation template is discarded from the Ad generation template DB 805 and consequently disregarded in future distribution generations of Ads. If the Ad generation template score is sufficiently high, a reproductive probability (RP) may be assigned to the Ad generation template based on the score 810. For example, a score S may be translated to an RP by taking RP=0.5ˆ[Nˆ(−|S|)], where N is a positive integer greater than 1. In an alternative embodiment, an RP score may be directly computed by and passed from the Feedback Evaluator module to the Ad Evolver module. Once an RP score has been established for the Ad generation template, the Ad Evolver module may stochastically reproduce, duplicate, or copy Ad generation templates with likelihoods based on their respective RP scores.

For example, the Ad Evolver may generate a random number (RAND) uniformly distributed between 0 and 1 at 815 and check whether the RP for a given Ad generation template is greater than RAND 820. If not, then the propagation of the Ad generation template may be demoted or inhibited 825 and, if RP>RAND, the propagation of the Ad generation template may be promoted 830. The probability that RP>RAND is equal to RP. Accordingly, this condition ties promotion of Ad template propagation to the probability score established at 810.

In alternative implementations, RAND may be taken to be a random variable with an arbitrary and/or non-uniform distribution in order to further weight the selection of Ad generation templates as desired for particular implementations of the present invention. At 835, a determination is made as to whether there are additional Ads to evaluate, and if so, the process returns to 801. In an alternative implementation, a single RAND is selected for comparison with RPs for all Ads under consideration at a given time. In another implementation, a single RAND is selected for all identical or related copies of an Ad generation template in the Ad generation template DB. In another alternate implementation, the selection probabilities may be used in combination with Ad generation template selection weightings. The Ad generation template selection weighting is a system tool used in distributing targeted advertisements to particular web users.

Promotion and/or demotion of Ad propagation may proceed in a number of different ways within various Ad duplication implementations of the present invention. In one implementation, promotion of Ad propagation may entail duplication of the Ad generation template into one or more identical copies in the Ad generation template DB. The existence of multiple, identical copies of a particular Ad generation template in the Ad generation template DB may increase the likelihood that the particular Ad generation template will be selected for future Ad generation. In one implementation, demotion of Ad propagation may entail deletion of one or more copies of an Ad generation template from the Ad generation template DB. In another implementation, the number of duplicate copies made or deleted for a given Ad generation template is affected by the Ad generation template score, RP, and/or the like. In an implementation, a particular Ad generation template score, RP, or difference between RAND and RP entails that the Ad generation template is neither deleted nor duplicated.

In another implementation, Ad generation template duplication and/or deletion is constrained by a requirement that the total number of Ad generation templates in the Ad generation template DB be equal to or within a specific range of a specified quota. In yet another implementation, promotion or demotion of Ad propagation may entail adjustment of a weighting factor associated with the Ad generation template. For example, this may occur in an embodiment wherein selection of an Ad generation template for Ad generation queries the Ad generation template weighting factor and preferentially selects Ad generation templates based on their corresponding weighting factors. In another implementation, the degree of adjustment to the weighting factor made for a given Ad generation template is affected by the Ad generation template score, RP, and/or the like.

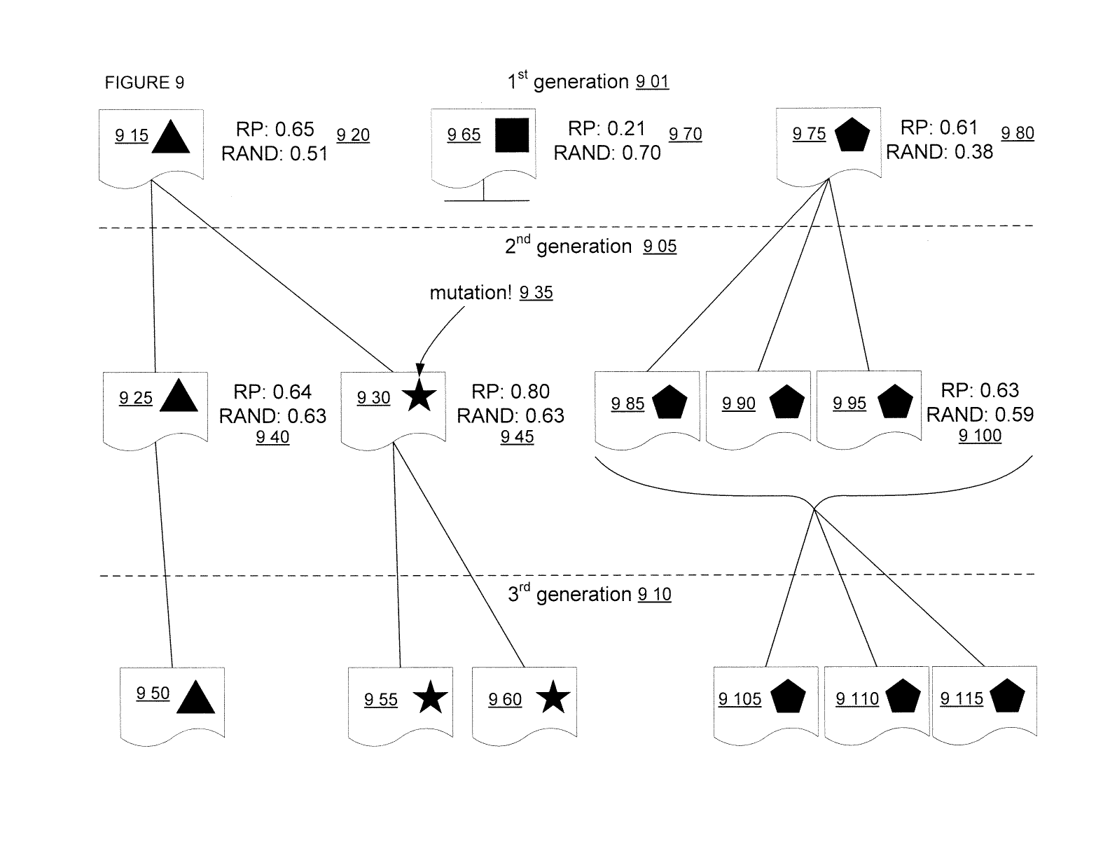

FIG. 9 exhibits a schematic, illustrative example of three generations (901, 905, 910) of Ad generation templates in one implementation of Ad duplication, where each Ad generation template's characterizing features are symbolically represented by a shape. For example, the features of Ad generation template 915 are represented by a triangle. The RP and RAND for the evolution of 915 are indicated at 920. In this illustrative implementation, an RP within 0.1 of RAND results in neither duplication nor deletion, RP<RAND −0.1 results in deletion, RAND+0.1<RP<RAND+0.2 results in single duplication (i.e., the original Ad generation template plus one copy), RAND+0.2<RP<RAND+0.3 results in double duplication, and so on. Thus, 915 is duplicated once, yielding second generation Ad generation templates 925 and 930. Ad generation template 930 has also acquired a “mutation” 935, or variation, in its characterizing features. Mutations are discussed in greater detail below. The RP and RAND for the evolution of 925 and 930 are indicated at 940 and 945 respectively (note the mutation 935 has resulted in a higher RP for 930 than for the parent template 915), and the resulting third generation Ad generation templates are exhibited at 950, 955, and 960.

The first generation Ad generation template 965 (characterizing features represented by a square) dies out in the first evolution stage due to its corresponding RP and RAND values 970. The first generation Ad generation template 975 (characterizing features represented by a pentagon) has corresponding RP and RAND values shown at 980. Consequently, it yields three second generation Ad generation template children (985, 990, and 995) which, collectively, have RP and RAND values shown at 9100 and, therefore, yield third generation children Ad generation templates (9105, 9110, and 9115).

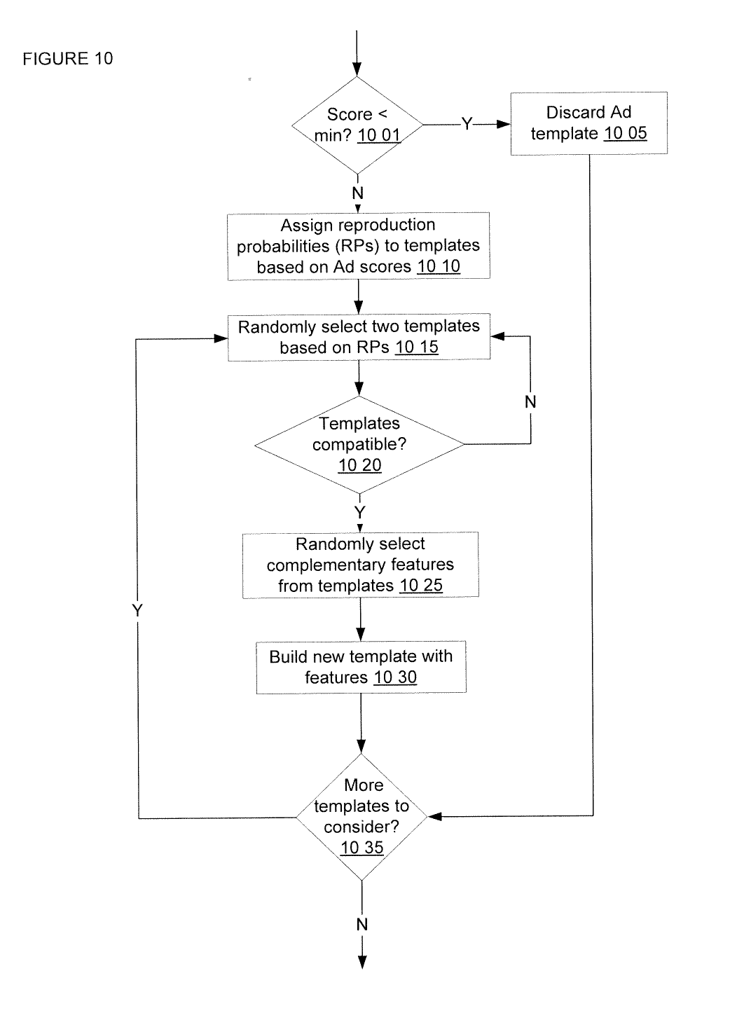

FIG. 10 provides an illustrative example of a logic flow associated with another embodiment of Ad evolution. In this embodiment, referred to as “Ad recombination”, web user responses to whole Ads are registered, processed by the Feedback Evaluator module 260 and passed to the Ad Evolver module 275. At 1001, the Ad Evolver checks if the Ad generation template score is less than some minimum value. If so, the particular Ad generation template is discarded 1005. Otherwise, the system assigns RPs to Ad generation templates based on the Ad generation template scores 1010. Two Ad generation templates to be recombined by the system are then selected with likelihood based on their RP values 1015. In an alternative implementation, more than two Ad generation templates may be selected for recombination at this stage. Selection of Ad generation templates may be accomplished, in one illustrative example, by generating a value for a uniformly distributed random variable RAND, separating Ad generation templates based on whether RP<RAND or RP>RAND, and selecting any two Ad generation templates randomly from the latter group with all Ad generation templates in this group treated on an equal footing.

At 1020, the system checks whether the Ad generation templates are compatible with each other. In one implementation, this may be accomplished by querying a collection of Ad generation template recombination rules that specify which Ad generation template elements and/or characteristics may render two Ads incompatible (for example, an Ad generation template configured to yield a banner Ad may be incompatible with an Ad generation template configured to yield memory-intensive video content). If the Ad generation templates are incompatible, the system returns to 1015 and selects new Ad generation template(s). Otherwise, complementary features are randomly selected from the two Ad generation templates at 1025.

In one implementation, this may be accomplished by randomly selecting half of the features in each Ad generation template. In another implementation, this may be accomplished by associating similar features in the Ad generation templates (e.g., headings, footings, design templates, size specifications, etc.) and then selecting randomly between matched features with equal probability for the features originating from each Ad generation template. Any leftover, unmatched features may, then, be randomly included or excluded in the final Ad generation template with equal probabilities. At 1030, the new Ad generation template is constructed from the Ad generation template features selected at 1025.

Finally, the system decides whether or not there are further Ad generation templates to consider at 1035. In one implementation, parent Ad generation templates are returned to the Ad generation template DB with the children Ad generation templates, while in another implementation, parent Ad generation templates may be discarded from the Ad generation template DB after a finite lifetime and/or number of generations. In one implementation, child Ad generation templates are made available for display to system administrators who may decide whether they are suitable for inclusion in the Ad generation template DB.

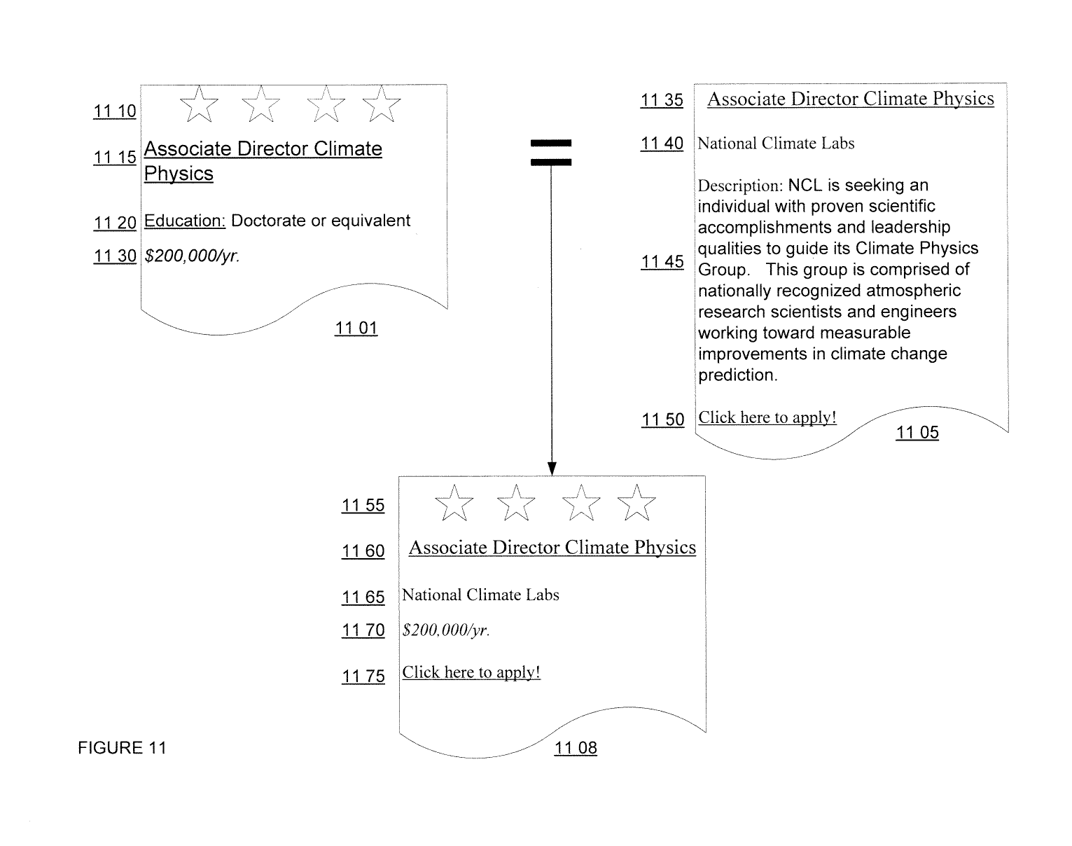

FIG. 11 shows an illustrative example of Ad recombination in one embodiment, whereby two parent Ad generation templates (1101 and 1105) are recombined into a child Ad generation template 1108. Though representations of the Ads themselves are shown in the figure for clarity, it may in fact be the underlying Ad generation templates that are recombined. Each Ad generation template underlying the Ads in FIG. 11 has a number of characterizing elements.

For example, Ad generation template 1101 specifies a star motif 1110; a global Arial font; a left-justified, 14 pt., underlined job title heading 1115; a left-justified, 12 pt. education level with underlined portion 1120; and a 12 pt., italicized salary. Ad generation template 1105, on the other hand, specifies a global Times New Roman font; a center-justified, 14 pt., underlined job title heading; a left-justified, 12 pt. company; a left-justified, 12 pt. job description; and a left-justified, 12 pt., underlined clickable link to more information. The child Ad generation template 1108 takes the star motif 1155 and salary specification 1170 from Ad generation template 1101 and the job title heading, company, and clickable link from Ad generation template 1105.

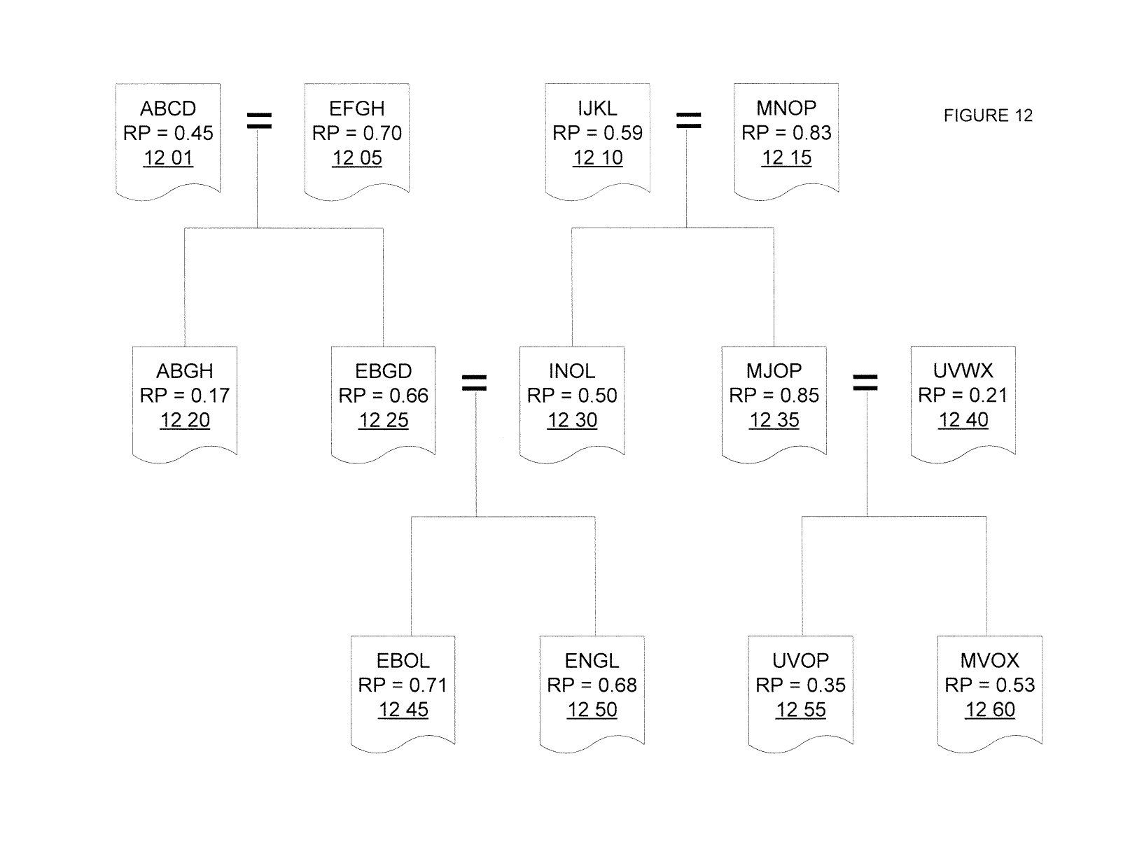

FIG. 12 provides a visualization of three successive Ad generation template generations in an Ad recombination embodiment. In this Ad generation template “family tree”, Ad generation template features are symbolized by four letters. For example, Ad generation template 1201 has features ABCD. A hypothetical RP value for each Ad generation template is also indicated (e.g., 1201 has RP=0.45). Parent templates (1201 with 1205 and 1210 with 1215) are recombined to form child templates (respectively 1220/1225 and 1230/1235), each possessing different combinations of parent template features. The combination of features in template 1220 apparently yields poor performance, as its RP=0.17 is low and, consequently, it yields no further children.

Templates 1225 and 1230 recombine to yield child templates 1245 and 1250, and template 1235 recombines with a newly introduced template 1240 to yield child templates 1255 and 1260. Both this family tree and the lineage chart in FIG. 9 provide visualizations of Ad generation template performance and evolution, and thus facilitate Ad performance tracking. In an implementation of the system, system administrators may access these types of evolutionary visualizations to assist in determining system performance and efficacy. Further, the evolutionary visualizations may be based on ad generation templates and/or distributed advertisements (e.g., illustrating ad templates 460 and/or distributed ads 470).

In one embodiment, Ad generation template evolution may be directed or restricted by grouping similar, compatible, and/or common-purpose Ad generation templates together based on Ad generation template characteristics and/or other labeling metadata. For example, the system may elect to only recombine Ad generation templates that generate pop-up Ads or to only recombine Ad generation templates marked with a “job listing template” metadata label with each other. This type of strategy respects the possibility that not all Ad types may be best served by the same Ad generation templates (e.g., consumer product Ads may be more effective with one template while job listings may be more effective with another).

In another embodiment, aspects of the Engine may be employed to target Ads to particular web users. For example, the system may monitor and collect web user interactions with a plurality of Ads, collect web user information, parse and/or separate collected interactions based on web user group identifiers (e.g., demographics, consumer behavior and/or shopping patterns, web surfing habits, address, education level, etc.), and serve Ads to each web user group generated using the most successful Ad generation templates and/or Ad generation routines within that group.

In another implementation, the system may elect to evolve Ad generation routines separately for different web user group identifiers. For example, web users with 2 or more children may have a wholly separate Ad evolution process from web users who have less than 2 children, yielding separate Ad generation template databases for each demographic group.

In another embodiment, particular Ad generation template elements and/or characteristics may be tied together or linked in such a way that they tend to carry over together from parent Ad generation templates into child Ad generation templates. For example, if two Ad generation template elements and/or characteristics (e.g., pop-up Ad and prominently featured salary) are correlated with a consistent and/or high-degree of performance success, they may be automatically coalesced into a single Ad generation template characteristic or brought to the attention of a system administrator who may elect to coalesce them.

Ad generation template elements and/or characteristics that are good candidates for coalescing may be identified heuristically by a system administrator using evolutionary visualizations discussed above or may be automatically detected. Automatic detection may proceed in a variety of different ways in various implementations of the present invention. In one implementation, the system may restrict its attention to Ad generation templates exhibiting the best performance (e.g., RP>0.9) in a given generation and then coalescing Ad generation template elements and/or characteristics that occur together most frequently in the set of best performing Ad generation templates. For example, if a large majority of the best performing Ad generation templates are pop-up Ads with a prominently featured salary, then these characteristics may be tied together into a single characteristic in subsequent generations.

In another embodiment, the system may admit restrictions on combinations of Ad generation template characteristics, preventing them from existing within a single Ad generation template in subsequent generations. Such restrictions may be implemented manually by a system administrator or automatically by the system itself. Ad generation template elements and/or characteristics that are good candidates for restriction may be identified heuristically by a system administrator or may be automatically detected.

Automatic detection may proceed in a variety of different ways in various implementations of the present invention. In one implementation, the system may restrict its attention to Ad generation templates exhibiting the worst performance (e.g., RP<0.1) in a given generation and then restrict Ad generation template elements and/or characteristics that occur together most frequently in the set of worst performing Ad generation templates. For example, if a large majority of worst performing Ad generation templates are banner Ads with a 300×600 size designation, then these characteristics may be restricted from occurring together in subsequent Ad generation templates. In one implementation, restrictions on Ad generation template element and/or characteristic combinations may be stored in a set of Ad generation template recombination rules.

In another embodiment, Ad generation template elements may be spontaneously and/or randomly changed by the system. Such changes, analogous to mutations in biological evolution, may yield novel Ad generation templates that may otherwise not have formed by other Ad evolution processes. In one implementation, child Ad generation templates may be randomly selected with a low probability to have one or more of their Ad generation template elements altered by the Engine. Such altering of Ad generation template elements may be accomplished, in one example, by replacing an Ad generation template element in the mutating Ad generation template with a randomly selected Ad generation template element from another randomly selected Ad generation template. In yet another embodiment, the system may admit manual changes to Ad generation templates and/or Ad generation template elements by a system administrator.

The Engine provides an efficient and effective Ad performance tracking and learning system that may be applied to a wide variety of marketing and information dispensation applications. In one embodiment, the Engine may process advertisements pertaining to job listings and/or opportunities. The same base job listing data entry may be incorporated into a variety of different formats that exhibit varying degrees of “attractiveness” and/or emphasize and/or de-emphasize various job listing elements. The Engine may then monitor the performance of the job listings by any of the means listed above and/or, in particular, by correlating web user applications for jobs, job interviews, or job offers with advertisement interactions and/or impressions. Subsequent job listing advertisements created by the system may be designed to exploit the most effective Ad generation template characteristics.

In another embodiment, the Engine may be employed to improve job seeker profiles and/or resume listings. A job seeker may submit characterizing information, profiles, and/or resumes to the system, which may then parse and/or incorporate the submission into a job seeker listing for display to possible employers. Performance of a job seeker listing may be measured by employer ratings and/or interactions with the listing, such as employer click-throughs, mouse-overs, impressions, interview offers, job offers, and/or the like. The job listings may then be refined based on the performance of various resume and/or job seeker listing generation templates. In one embodiment, analysis of template performance may form the basis for a resume and/or job seeker listing consultation service.

In another embodiment, the Engine may form the basis for a graded advertisement pricing system. In tracking Ad generation template performance, the Engine may determine the degree to which particular Ad generation templates and/or Ad generation template elements contribute to Ad effectiveness. Consequently, a graded advertisement pricing system may be established, whereby a graded premium may be charged to companies supplying base data entries for inclusion in advertisements for the use of Ad generation templates and/or Ad generation template elements proven to be most attractive and/or effective in eliciting desired web user responses. In another embodiment, Ad generation templates and/or Ad generation template elements that yield particularly high performance metric scores may be marked by the system as candidates for intellectual property protection. These marked templates may be brought to the attention of a system administrator or automatically submitted for legal consideration.

Advertisement Evolution Engine Controller

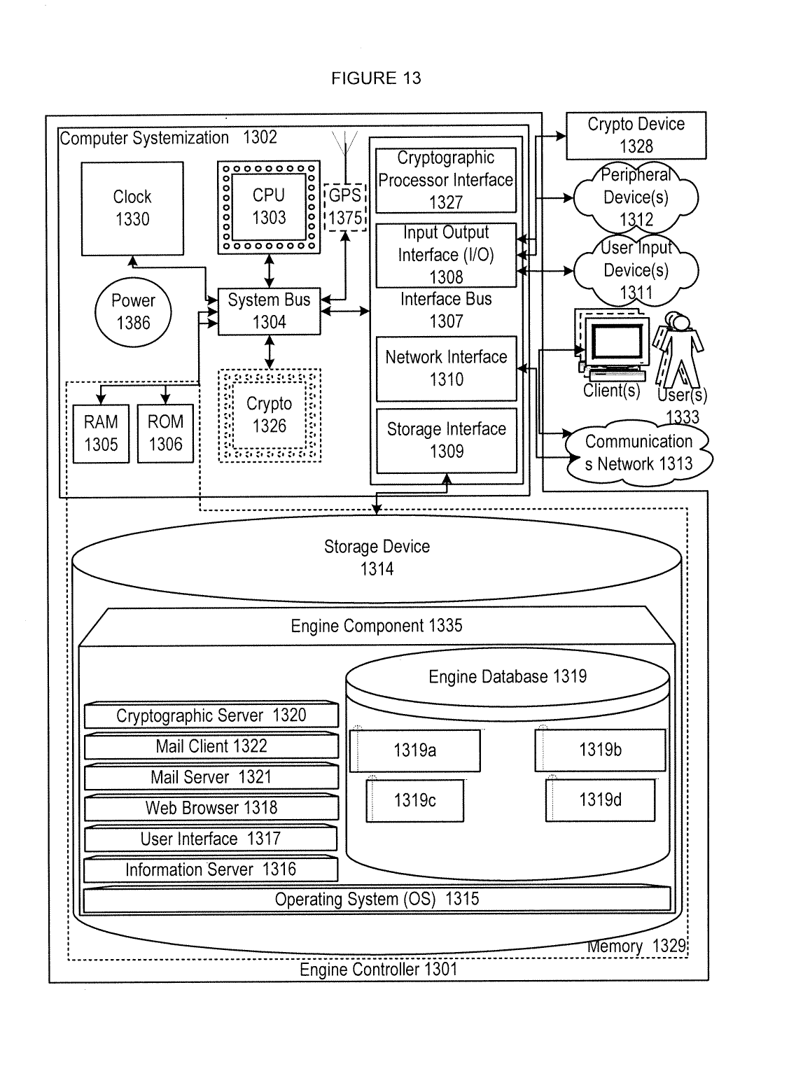

The advertisement server and generators described above can be embodied by an advertisement evolution Engine (“Engine”) controller 1301. FIG. 13 of the present disclosure exhibits illustrates inventive aspects of the Engine controller 1301 in a block diagram. In this embodiment, the Engine controller 1301 may serve to generate, manage, price, sell, match, display, serve, and distribute advertisements.

Computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the Engine controller 1301 may be connected to and/or communicate with entities such as, but not limited to: one or more users from user input devices 1311; peripheral devices 1312; a cryptographic processor device 1328; and/or a communications network 1313.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Engine controller 1301 may be based on common computer systems that may comprise, but are not limited to, components such as: a computer systemization 1302 connected to memory 1329.

Computer Systemization

A computer systemization 1302 may comprise a clock 1330, central processing unit (CPU) 1303, a read only memory (ROM) 1306, a random access memory (RAM) 1305, and/or an interface bus 1307, and most frequently, although not necessarily, are all interconnected and/or communicating through a system bus 1304. Optionally, the computer systemization may be connected to an internal power source 1386. Optionally, a cryptographic processor 1326 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the Engine controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 1386 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 1386 is connected to at least one of the interconnected subsequent components of the Engine thereby providing an electric current to all subsequent components. In one example, the power source 1386 is connected to the system bus component 1304. In an alternative embodiment, an outside power source 1386 is provided through a connection across the I/O 1308 interface. For example, a USB and/or IEEE 1394 connection carries both data and power across the connection and is therefore a suitable source of power.

Interface Adapters

Interface bus(ses) 1307 may accept, connect, and/or communicate to a number of interface adapters, conventionally although not necessarily in the form of adapter cards, such as but not limited to: input output interfaces (I/O) 1308, storage interfaces 1309, network interfaces 1310, and/or the like. Optionally, cryptographic processor interfaces 1327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1309 may accept, communicate, and/or connect to a number of storage devices such as, but not limited to: storage devices 1314, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1310 may accept, communicate, and/or connect to a communications network 1313. Through a communications network 1313, the Engine controller is accessible through remote clients 1333b (e.g., computers with web browsers) by users 1333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1310 may be used to engage with various communications network types 1313. For example, multiple network interfaces may be employed to allow for the communication over broadcast, multicast, and/or unicast networks.

Input Output interfaces (I/O) 1308 may accept, communicate, and/or connect to user input devices 1311, peripheral devices 1312, cryptographic processor devices 1328, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1311 may be card readers, dongles, finger print readers, gloves, graphics tablets, joysticks, keyboards, mouse (mice), remote controls, retina readers, trackballs, trackpads, and/or the like.

Peripheral devices 1312 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Engine controller may be embodied as an embedded, dedicated, and/or monitor-less (i.e., headless) device, wherein access would be provided over a network interface connection.

Cryptographic units such as, but not limited to, microcontrollers, processors 1326, interfaces 1327, and/or devices 1328 may be attached, and/or communicate with the Engine controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 740 MHz Roadrunner.

Memory

Generally, any mechanization and/or embodiment allowing a processor to affect the storage and/or retrieval of information is regarded as memory 1329. However, memory is a fungible technology and resource, thus, any number of memory embodiments may be employed in lieu of or in concert with one another. It is to be understood that the Engine controller and/or a computer systemization may employ various forms of memory 1329. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1329 will include ROM 1306, RAM 1305, and a storage device 1314. A storage device 714 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 1329 may contain a collection of program and/or database modules and/or data such as, but not limited to: operating system module(s) 1315 (operating system); information server module(s) 1316 (information server); user interface module(s) 1317 (user interface); Web browser module(s) 1318 (Web browser); database(s) 1319; cryptographic server module(s) 1320 (cryptographic server); the Engine module(s) 1335; and/or the like (i.e., collectively a module collection). These modules may be stored and accessed from the storage devices and/or from storage devices accessible through an interface bus. Although non-conventional software modules such as those in the module collection, typically, are stored in a local storage device 1314, they may also be loaded and/or stored in memory such as: peripheral devices, RAM, remote storage facilities through a communications network, ROM, various forms of memory, and/or the like.

Operating System

The operating system module 1315 is executable program code facilitating the operation of the Engine controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the Engine controller to communicate with other entities through a communications network 1313. Various communication protocols may be used by the Engine controller as a subcarrier transport mechanism for interaction, such as, but not limited to: multicast, TCP/IP, UDP, unicast, and/or the like.

Information Server

An information server module 1316 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the Engine controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 1321, and/or the like. An information server may communicate to and/or with other modules in a module collection, including itself, and/or facilities of the like. Most frequently, the information server communicates with the Engine database 1319, operating systems, other program modules, user interfaces, Web browsers, and/or the like.

Access to the Engine database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Engine. In one embodiment, the information server would provide a Web form accessible by a Web browser. Entries made into supplied fields in the Web form are tagged as having been entered into the particular fields, and parsed as such. The entered terms are then passed along with the field tags which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Engine as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 1317 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 1318 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Engine enabled nodes. The combined application may be nugatory on systems employing standard Web browsers.

Cryptographic Server

A cryptographic server module 1320 is stored program code that is executed by the CPU 1303, cryptographic processor 1326, cryptographic processor interface 1327, cryptographic processor device 1328, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Engine may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for an digital audio file. A cryptographic module may communicate to and/or with other modules in a module collection, including itself, and/or facilities of the like. The cryptographic module supports encryption schemes allowing for the secure transmission of information across a communications network to enable the Engine module to engage in secure transactions if so desired. The cryptographic module facilitates the secure accessing of resources on the Engine and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

The Engine Database

The Engine database module 1319 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Engine database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Engine database is implemented as a data-structure, the use of the Engine database 1319 may be integrated into another module such as the Engine module 1335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database module 1319 includes several tables 19a-c. A base data entry table 1319a includes fields such as, but not limited to: sponsor ID, preferred content IDs, related base data entries, and/or the like. A generation rule set table 1319b includes fields such as, but not limited to: web user group labels, allowed template characteristic combinations, restricted template characteristic combinations, and/or the like. An Ad generation template table 1319c includes fields such as, but not limited to: Ad generation template ID, parsing priority, key term elements, location element, salary element, opportunity type element, performance history, and/or the like. An content provider table 1319d includes fields such as, but not limited to: content provider ID, provider content, web user info, Ad format restrictions, and/or the like.

In one embodiment, the Engine database may interact with other database systems. For example, employing a distributed database system, queries and data access by the Engine modules may treat the combination of the Engine database and other databases as a single database entity.

In one embodiment, user programs may contain various user interface primitives, which may serve to update the Engine. Also, various accounts may require custom database tables depending upon the environments and the types of clients the Engine may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database modules 1319a-c. The Engine may be configured to keep track of various settings, inputs, and parameters via database controllers.

The Engine database may communicate to and/or with other modules in a module collection, including itself, and/or facilities of the like. Most frequently, the Engine database communicates with the Engine module, other program modules, and/or the like. The database may contain, retain, and provide information regarding other nodes and data.

The Engine

The Engine module 1335 is stored program code that is executed by the CPU. The Engine affects accessing, obtaining and the provision of information, services, transactions, and/or the like across various communications networks.

The Engine module enables generation of transactions for investors to contribute to such various asset funds and achieve investment fund optimizations for such exchanges.

The Engine module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. In one embodiment, the Engine server employs a cryptographic server to encrypt and decrypt communications. The Engine module may communicate to and/or with other modules in a module collection, including itself, and/or facilities of the like. Most frequently, the Engine module communicates with the Engine database, operating systems, other program modules, and/or the like. The Engine may contain, communicate, generate, obtain, and/or provide program module, system, user, and/or data communications, requests, and/or responses.

Distributed Engine

The structure and/or operation of any of the Engine node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the Engine controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method for generating advertisements, comprising:
generating a plurality of advertisements from the same base data entry;
distributing the plurality of advertisements for evaluation;
receiving one or more performance rating parameters associated with one of the plurality of advertisements;
processing the received one or more performance rating parameters to determine a relative efficacy indicator associated with an advertisement generation routine; and
maintaining a relative efficacy listing of advertisement generation routines used to generate each advertisement.

2. The method of claim 1, wherein two or more of the plurality of advertisements are distributed to the same target destination.

3. The method of claim 1, wherein the performance rating parameters are based on web user ratings of advertisement characteristics.

4. The method of claim 3, wherein the advertisement characteristics are related to an overall attraction indicator associated with the advertisement.

5. The method of claim 3, wherein the advertisement characteristics are related to a specific listing parameter attraction indicator associated with the advertisement.

6. The method of claim 1, wherein the performance rating parameters are related to web user advertisement interaction characteristics.

7. The method of claim 6, wherein the web user advertisement interaction characteristics include a web user click-through of a distributed advertisement.

8. The method of claim 6, wherein the web user advertisement interaction characteristics include a web user mouse-over of a distributed advertisement.

9. The method of claim 6, wherein the web user advertisement interaction characteristics include a web user text input in a distributed advertisement.

10. The method of claim 6, wherein the web user advertisement interaction characteristics include a web user submission that is correlated to a click-through of a distributed advertisement.

11. The method of claim 6, wherein the web user advertisement interaction characteristics include a web user registration that is correlated to a click-through of a distributed advertisement.

12. The method of claim 6, wherein the web user advertisement interaction characteristics include a web user job listing fulfillment that is correlated to a click through of a distributed advertisement.

13. A processor-implemented method for creating advertisements comprising:
receiving an advertisement request;
selecting at least two advertisement generation templates;
creating a distribution advertisement for each selected ad generation template;
retrieving a base data entry;
extracting base data entry elements; and
incorporating the base data entry elements into the created distribution advertisement in accordance with the respective advertisement generation template.

14. The method of claim 13, further comprising:
receiving a distributed advertisement performance indicator for a distributed advertisement;
correlating the performance indicator with an advertisement performance metric parameter; and
updating an advertisement generation template score, wherein the advertisement generation template score is associated with the distributed advertisement and a corresponding advertisement generation template.

15. The method of claim 14, further comprising:
managing a collection of advertisement generation templates.

16. The method of claim 15, wherein the corresponding advertisement generation template is removed from the collection based on the advertisement generation template score.

17. The method of claim 15, wherein the corresponding advertisement generation template is duplicated within the collection based on the advertisement generation template score.

18. The method of claim 15, wherein advertisement generation templates are duplicated within the collection based on the advertisement generation template score associated with the advertisement generation template.

19. The method of claim 14, wherein the selection of the advertisement generation template is based on a weighted selection index.

20. The method of claim 14, wherein the selection of the advertisement generation template is based a weighted selection index derived from the advertisement generation template score.

21. A system for generating advertisements, comprising:
generate a plurality of advertisements from the same base data entry;
distribute the plurality of advertisements for evaluation;
receive one or more performance rating parameters associated with one of the plurality of advertisements;
process the received one or more performance rating parameters to determine a relative efficacy indicator associated with an advertisement generation routine; and
maintain a relative efficacy listing of advertisement generation routines used to generate each advertisement.

22. The system of claim 1, wherein two or more of the plurality of advertisements are distributed to the same target destination.

23. The system of claim 1, wherein the performance rating parameters are based on web user ratings of advertisement characteristics.

24. The system of claim 3, wherein the advertisement characteristics are related to an overall attraction indicator associated with the advertisement.

25. The system of claim 3, wherein the advertisement characteristics are related to a specific listing parameter attraction indicator associated with the advertisement.

26. The system of claim 1, wherein the performance rating parameters are related to web user advertisement interaction characteristics.

27. The system of claim 6, wherein the web user advertisement interaction characteristics include a web user click-through of a distributed advertisement.

28. The system of claim 6, wherein the web user advertisement interaction characteristics include a web user mouse-over of a distributed advertisement.

29. The system of claim 6, wherein the web user advertisement interaction characteristics include a web user text input in a distributed advertisement.

30. The system of claim 6, wherein the web user advertisement interaction characteristics include a web user submission that is correlated to a click-through of a distributed advertisement.

31. The system of claim 6, wherein the web user advertisement interaction characteristics include a web user registration that is correlated to a click-through of a distributed advertisement.

32. The system of claim 6, wherein the web user advertisement interaction characteristics include a web user job listing fulfillment that is correlated to a click through of a distributed advertisement.

33. A system for creating advertisements comprising:
a memory;
a processor disposed in communication with said memory, and configured to issue a plurality of processing instructions stored in the memory, wherein the instructions issue signals to:
receive an advertisement request;
select at least two advertisement generation templates;
create a distribution advertisement for each selected ad generation template;
retrieve a base data entry;
extract base data entry elements; and
incorporate the base data entry elements into the created distribution advertisement in accordance with the respective advertisement generation template.

34. The system of claim 13, further comprising instructions configured to:
receive a distributed advertisement performance indicator for a distributed advertisement;
correlate the performance indicator with an advertisement performance metric parameter; and
update an advertisement generation template score, wherein the advertisement generation template score is associated with the distributed advertisement and a corresponding advertisement generation template.

35. The system of claim 14, further comprising instructions configured to:
manage a collection of advertisement generation templates.

36. The system of claim 15, wherein the corresponding advertisement generation template is removed from the collection based on the advertisement generation template score.

37. The system of claim 15, wherein the corresponding advertisement generation template is duplicated within the collection based on the advertisement generation template score.

38. The system of claim 15, wherein advertisement generation templates are duplicated within the collection based on the advertisement generation template score associated with the advertisement generation template.

39. The system of claim 14, wherein the selection of the advertisement generation template is based on a weighted selection index.

40. The system of claim 14, wherein the selection of the advertisement generation template is based a weighted selection index derived from the advertisement generation template score.
